(19) United States
(12) Patent Application Publication
(10) Pub. No.: US 2011/0293494 A1
(43) Pub. Date: Dec. 1, 2011

(54) PROCEDURE FOR OBTAINING CALCIUM ALUMINATE FROM WASTE OBTAINED FOLLOWING TREATMENT OF SALINE DROSS FROM THE PRODUCTION OF SECONDARY ALUMINIUM

(75) Inventors: José Martinez Iglesias, Aviles (Asturias) (ES); Alejandro Salinas Tuya, Aviles (Asturias) (ES); Fernando Marquinez Peña, Aviles (Asturias) (ES)

(73) Assignee: ASTURIANA DE ALEACIONES, S.A., Aviles (Asturias) (ES)

(21) Appl. No.: 13/145,060

(22) PCT Filed: Jan. 20, 2010
(86) PCT No.: PCT/ES2010/000016

§ 371 Date: Jul. 18, 2011

(30) Foreign Application Priority Data
Jan. 20, 2009 (ES) P200900149

(51) Int. Cl. C01F 7/16; C22B 1/245

(52) U.S. Cl. 423/115; 264/128

(57) ABSTRACT

Procedure for obtaining calcium aluminate from the dry waste generated in the treatment, for recovery of metallic Al and salts, of the saline dross produced in the metallurgy of secondary aluminium and calcium oxide and/or CaO precursor. The procedure may produce briquettes or pellets of precursors of calcium aluminate through cold sintering or premolten calcium aluminate through hot sintering.

### FIELD OF THE INVENTION

The procedure of the invention falls within the technical field of industrial waste recovery, particularly the use of the waste obtained from treatment of saline dross generated by the industry of secondary aluminium, which so far has little industrial application and is considered harmful from the environmental point of view.

It may also be considered as a procedure to produce calcium aluminate as an additive, for example, for the metallurgy of steel.

### BACKGROUND OF THE INVENTION

The calcium aluminates are described in the CaO—Al₂O₃ binary phases diagram. As shown in FIG. 1 the hydraulic characteristics shown by some of its crystalline phases and their stability at high temperatures have made them suitable for use as refractory cement.

Another of its applications is within the metallurgical process of steel manufacturing, where the contribution of synthetic dross on calcium aluminate base favours the process of desulfurization of the steel and obtaining steel free of inclusions, especially Al₂O₃. Furthermore, the presence of a molten calcium aluminate dross on the steel facilitates the work in the secondary metallurgy, due to its suitable fluidity, and protects the steel against reoxidation processes and losses of temperature. In this sense, it is possible to find complete information in McGannon, “The Making, Shaping and Treating of Steel”, or in patent documents such as U.S. Pat. No. 4,490,173, “Steelmaking additive composition”.

Premolten calcium aluminates have proven to be the most suitable for use in metallurgical processes. This is due to increased melting rate compared, for example, with the use of mixtures of bauxite (high content in Al₂O₃) and CaO where the melting time increases by being preceded by a solid-solid reaction between components. The addition of mixtures of components (Al₂O₃+CaO) in fine particle sizes would increase the reaction and hence melting rates, but an excessive generation of dust and performance losses caused by uptake of smoke, have limited this practice.

Most of the calcium aluminate consumed by the steel sector is synthesized from mixtures of bauxite and limestone. In this line firms like Kerneos offer a wide range of premolten calcium aluminates. On the other hand, there are products on the market where the contribution of a mixture of CaO and finely ground bauxite on a bath of molten steel leads to the formation of calcium aluminate in situ by the effect of the high temperature of the steel.

The use of dross from the melting of aluminium, and therefore with a high content of Al₂O₃, has been shown as an alternative to the use of bauxite for the production of calcium aluminates.

In this regard, U.S. Pat. No. 5,385,601, “Process for recovering aluminium dross to ladle flux for steel Processing” describes the production of calcium aluminates from aluminium dross, regardless of its composition, and flux with base of SiO₂ and/or CaO by melting at 1490° C. In ES2124425 “Procedimiento para la preparación de aluminatos calcicos a partir de residuos de escorias de aluminio” the formation of calcium aluminates starting from aluminium dross that have not been generated in the presence of salts is described. Similarly, U.S. Pat. No. 716,426 “Methods of processing aluminium dross and aluminium dross residue into calcium aluminate” proposes obtaining calcium aluminates in a single process of two consecutive steps, first the treatment of dross for the recovery of aluminium and second the treatment of the resulting dross with Ca(OH)₂, followed by calcination.

As it has already been discussed, all the processes for the formation of existing calcium aluminates pass through processes at high temperatures above 1300° C. This makes said processes economically costly, due to high energy and production costs.

The present invention proposes a procedure for the formation of calcium aluminates using the waste from treatment, for the recovery of metallic Al and salts, of the saline dross produced in the metallurgy of the secondary aluminium. This procedure allows the formation of calcium aluminate precursors using cold sintering or a premolten product. On the other hand, the present invention allows the use and recovery of waste generated after treatment of saline dross carried out by aluminium dross management companies.

### DESCRIPTION OF THE INVENTION

During the melting of secondary aluminium and/or aluminium dross, mixtures of sodium and potassium chlorides are used to cover the molten material, prevent oxidation, increase the yield and increase thermal efficiency of furnaces. This process generates large amounts of dross, known as “saline type dross.” The treatment of saline dross carried out by restoring companies such as Remetal, Alsa, Engitec and the like, is the alternative to dumping. This treatment is aimed at the separation of metallic aluminium and salts, resulting in a waste with few industrial applications, plus, the generation of stocks with the consequent economic cost and waste devaluation.

For its treatment, the dross is subjected to a grinding and dilution process. In this process and because the aluminium does not dissolve, the same and a slurry composed of alumina and salts are recovered. The liquid phase of the sludge shall be composed of salts in solution, while the solid phase will be a mixture of alumina, silica and various metal oxides. After drying the solid phase a dry waste is obtained, which is the base feedstock for the development of the present invention.

Starting from this dry waste, in the process, a shaped product, briquette- or pellet-type, or a premolten can be obtained. The dimensions of the final product will be adjusted to the needs of the industrial application to which it is directed.

The procedure comprises a first step of mixing of components, dry waste and calcium oxide and/or CaO precursor, in a ratio that should be calculated to obtain a final CaO/Al₂O₃ ratio between 0.2 and 1.80 in terms of its industrial application.

The second step is a grinding, homogenization and sieving to obtain particles of suitable size for the process. Although this step may be optional, since it is not necessary if the dry waste and the calcium oxide and/or CaO precursor are provided with the suitable particle size.

In the procedure with cold sintering the next one is a fifth step, which consists of adding and mixing with a binder. In the sixth step the briquettes or pellets are formed by feeding a forming machine with the mixture of calcium aluminate precursors and binder. A seventh step of product drying and finally an eighth step of packaging in bags, big-bag or bulk.

As a result of this process a product with the shape of briquettes or pellets is obtained, with sufficient mechanical strength for its handling, which can be used, for example, in the metallurgy of steel, combining the properties of good melting rate for forming calcium aluminates and the absence of harmful dust in the environment.

In the case of wanting to obtain premolten calcium aluminates, these are achieved by sintering or hot-melt, and is added a third step consisting of treatment of the precursors in a furnace of the type: rotary, reverberatory, mobile belt or the like at temperatures of 1400° C., a fourth step of cooling, grinding and sorting. And a final step of packaging in bags, Big-bag or bulk.

The final product can be packaged in the most convenient way to be supplied to end-users.

To these steps others (water addition or intermediate drying, for example) can be added to improve the characteristics of the process, or other components that improve the product can be added, all without altering the essence of the invention.

The present invention makes available precursors or premolten calcium aluminate obtained from dry waste obtained after treatment, for the recovery of metallic Al and salts, of the saline dross produced in the metallurgy of the secondary aluminium.

### BRIEF DESCRIPTION OF THE DRAWINGS

Two drawings are provided to help better understand the invention and which are specifically related to the embodiment of said invention that is presented as an illustrative and not limitative example thereof.

FIG. 1 is the CaO—Al₂O₃ binary phases diagram

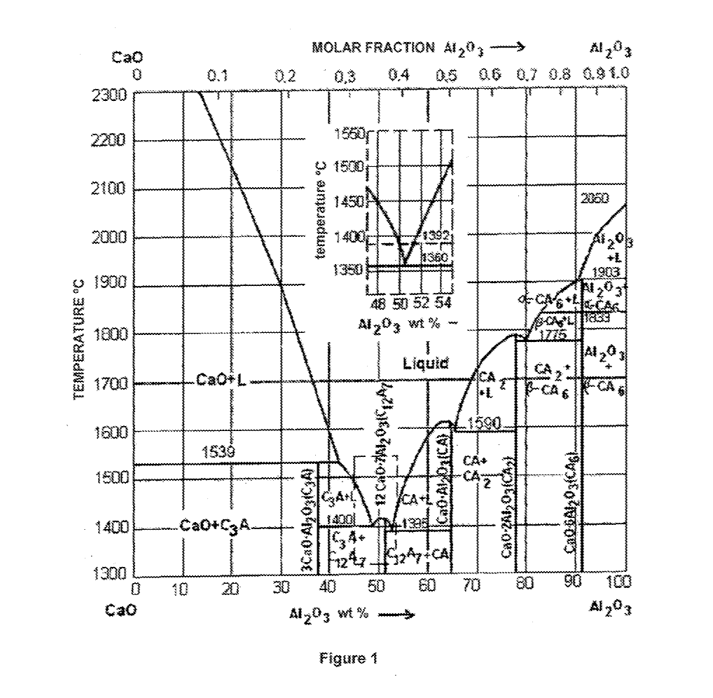

FIG. 2 is the X-ray diffraction (XRD) obtained from the final product.

FIG. 3 is the diagram of the process of the invention, with cold sintering.

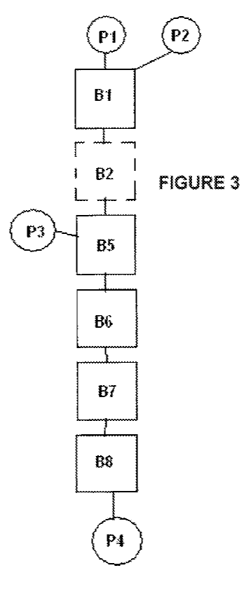

FIG. 4 is the diagram of the process of the invention, with hot sintering.

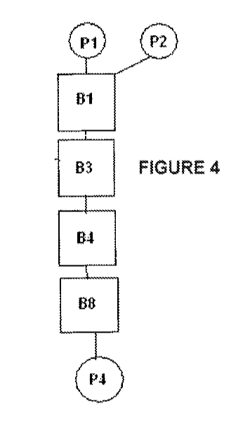

The references mean the following:
Steps of the process:
   B1: Mixing of the dry waste with CaO and/or of CaO precursor

With cold sintering:
B2: Grinding, homogenization and sieving (optional)
B5: Mixing with binder
B6: Formation of the briquette or pellet
B7: Drying of the product (optional)
B8: Packaging: Bags, Big-bag or bulk

With hot sintering:
B3: Heating in furnace of the type: rotary, reverberatory, mobile belt or similar
B4: Cooling, grinding and sorting
B8: Packaging: Bags, Big-bag or bulk

Products in the process:
P1: dry waste (waste from the treatment of dross saline)
P2: calcium oxide and/or CaO precursors
P3: Binder
P4: Briquettes or Pellets of calcium aluminate precursors and/or premolten calcium aluminate.

### DESCRIPTION OF A PREFERRED EMBODIMENT OF THE INVENTION

A specific example of embodiment of the invention starts from the dry waste produced after treatment, for the recovery of metallic Al and salts, of the saline dross produced in the metallurgy of the secondary aluminium. This dry waste is produced, so far with few applications, by restoring companies such as Remetal, Alsa or Engitec. The dry waste (P1) has a composition that is approximately as follows:

Al₂O₃→50-80%

SiO₂→3-15%

MgO→2-10%

CaO→0.5-5%

TiO₂→0.4%

MnO→0.4%

The first step of the procedure (B1) is the mixture of the dry waste (P1) and calcium oxide and/or CaO precursors (P2), at a rate that is calculated to obtain a final CaO/Al₂O₃ ratio between 0.2 and 1.80 according to the industrial application. In the example, calcium oxide is supplied with a particle size less than 2 mm, so the second optional step (B2) (grinding, homogenization and sieving) is not necessary.

In the case of seeking a cold sintered product of calcium aluminate precursors, it continues with the fifth step (B5) in which the binder (P3) is added. In the case of wanting to form briquettes, calcium stearate, wax, molasses, resins, Ca(OH)₂, aluminous cements, solid tar, Polyetilenglicol (PEG), carboxymethylcellulose (CMC), silicates, alginates or Polyvinylpyrrolidine (PVP) have been tested, obtaining good results with any of them. Once the mixture has been homogenized it is proceeded to, in the sixth step (B6), feed the briquetting machine. This results in briquettes (P4), for example of about 40 mm (although the dimensions can be between 4 mm and 100 mm), ready to be packaged and delivered to the end user.

In the case of wanting to obtain the product (P4) in the form of pellets, it has been proven that is better to use wax, molasses, resins, Ca(OH)2, liquid tar, Polyetilenglicol (PEG), carboxymethylcellulose (CMC), silicates, alginates, Polyvinylpyrrolidine (PVP) or aluminous cements as a binder (P3). Once the mixture is homogenized water will be added if necessary and continue with the sixth step (B6), which in this case will be feeding a palletizing plate. Again, the size of the pellets will depend on the application and may vary between 1 and 50 mm in diameter.

If necessary, it is proceeded with the drying of the pellets or briquettes (B7). After that, it will continue with the packaging (B8) for supplying the product of calcium aluminate precursors (P4).

As a result of this process a product (P4) in the form of briquettes or pellets is obtained, with the following composition:

Al₂O₃→37%

CaO→43%

SiO₂→4.3%

MgO→3.4%

These briquettes or pellets can be used, for example, in the metallurgy of steel and as a desulfurizing, collector of inclusions, or for protecting steel against reoxidation processes and losses of temperature. Furthermore, the briquettes and/or pellets of calcium aluminate precursors of the invention have the properties of good melting rate for forming calcium aluminates and the absence of harmful dust in the environment.

In the case of wanting to obtain premolten calcium aluminates, these are achieved by hot sintering in a third optional step (B3) consisting of a treatment of the precursors by feeding the homogeneous mixture obtained in step (B1) into a furnace of the type: rotary, reverberatory, mobile belt or the like at temperatures above 1100° C. Then there is a fourth step (B4) in which the mixture is cooled and ground and a final step (B8) of packaging.

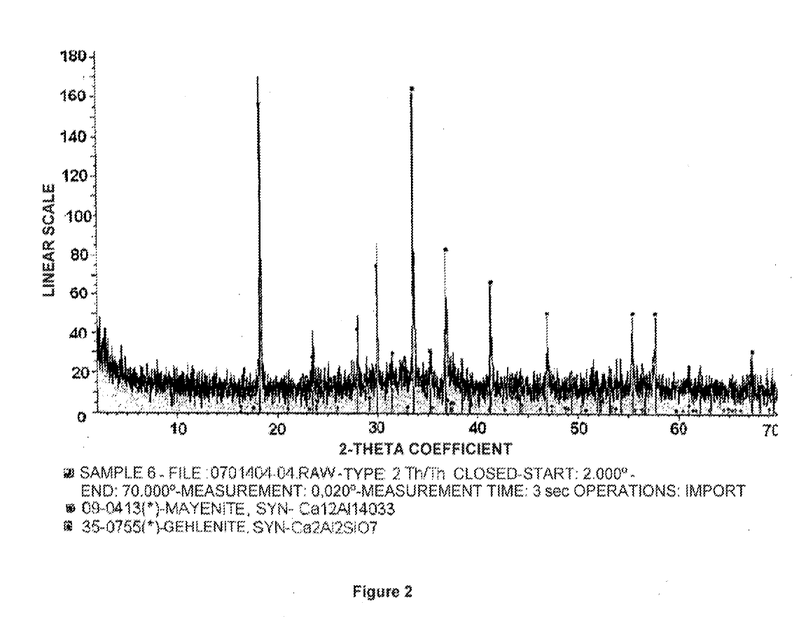

The product obtained by any of the procedures of the invention was subjected to trials that indicate that its properties are perfectly valid to be used, for example, in the metallurgy of steel. Thus, the product has a suitable melting rate and point (meting T<1350° C.), mainly forming the C12A7 (Caₗ₂Al₁₄O₃₃) crystalline phase of CaO—Al₂O₃ binary diagram. FIG. 2 shows the X-ray diffraction obtained by one of the products (P4) obtained.

1. Procedure for obtaining calcium aluminate from waste from the treatment of saline dross characterized by using as feedstock the dry waste (P1) generated after treatment, for the recovery of the metallic Al and salts, of the saline dross produced in the metallurgy of the secondary aluminium and calcium oxide and/or CaO precursor (P2).

2. Procedure for obtaining calcium aluminate from waste from the treatment of saline dross according to claim 1 wherein it comprises at least one first step (B1) of mixing the dry waste (P1) and calcium oxide and/or CaO precursor (P2), a fifth step (B5) in which a binder (P3) is added, a sixth step (B6) in which briquettes or pellets of calcium aluminate precursors (P4) are formed by means of a forming machine, a seventh step (B7) of drying of the product and an eighth step (B8) of packaging.

3. Procedure for obtaining calcium aluminate from waste from the treatment of saline dross according to claim 1 wherein it comprises, between the first (B1) and the third (B3) steps at least one second step (B2) comprising a grinding, homogenization and sieving to obtain a suitable particle size for the formation of the product.

4. Procedure for obtaining calcium aluminate from waste from the treatment of saline dross according to claim 1 wherein on the first step (B1) the dry waste (P1) and calcium oxide and/or CaO precursor (P2) are mixed at a rate that is calculated to obtain a CaO/Al₂O₃ ratio in the final product (P4) between 0.2 and 1.80.

5. Procedure for obtaining calcium aluminate from waste from the treatment of saline dross according to claim 1 wherein in the fifth step (B5) a binder (P3) comprising calcium stearate, wax, molasses, resins, Ca(OH)₂, solid tar, Polyetilenglicol (PEG), carboxymethylcellulose (CMC), silicates, alginates, Polyvinylpyrrolidine (PVP) or aluminous cements is added.

6. Procedure for obtaining calcium aluminate from waste from the treatment of saline dross according to claim 1 wherein in the sixth step (B6) a briquetting-type cold forming machine is used.

7. Procedure for obtaining calcium aluminate from waste from the treatment of saline dross according to claim 1 wherein in the sixth step (B6) a palletizing plate is used.

8. Procedure for obtaining calcium aluminate from waste from the treatment of saline dross according to claim 1 wherein it includes, if necessary, a seventh step (B7) of drying of the product.

9. Procedure for obtaining calcium aluminate from waste from the treatment of saline dross according to claim 1 wherein it includes an eighth step (B8) of packaging in bags, big-bag or bulk.

10. Procedure for obtaining calcium aluminate from waste from the treatment of saline dross according to claim 1 wherein it comprises, after the first step (B1) at least one third step (B3) for heating the dry waste (P1) and calcium oxide and/or CaO precursor (P2) at temperatures above 1100° C. in a furnace of the type: rotary, reverberatory, mobile belt or the like, a fourth step (B4) of cooling, grinding and sorting, and a final step (B8) of packaging in bags, big-bag or bulk.
